(19) United States
(12) Patent Application Publication
(10) Pub. No.: US 2026/0302478 A1
(43) Pub. Date: Oct. 1, 2026

(54) BATTERY SYSTEM

(71) Applicant: HONDA MOTOR CO., LTD., Tokyo (JP)

(72) Inventors: Daichi WATANABE, Saitama (JP); Nobuyuki AKAISHI, Saitama (JP)

(21) Appl. No.: 19/577,835

(22) Filed: Mar. 25, 2026

(30) Foreign Application Priority Data
Mar. 31, 2025 (JP) 2025-059165

(51) Int. Cl. H01M 50/242; B60L 50/64; B60L 58/12; B60L 58/24; B60R 16/033; H01M 10/48; H01M 10/613; H01M 10/615; H01M 10/625; H01M 10/633; H01M 10/6568; H01M 50/249

(52) U.S. Cl. CPC H01M 50/242; B60R 16/033; H01M 10/482; H01M 10/613; H01M 10/615; H01M 10/625; H01M 10/633; H01M 10/6568; H01M 50/249; B60L 50/64; B60L 58/12; B60L 58/24; B60L 2240/545; H01M 2220/20

(57) ABSTRACT

A battery system includes: a battery cell; and an elastic member that is provided adjacent to the battery cell, and has a contact surface pressure against the battery cell that changes depending on expansion and contraction of the battery cell. The battery system includes: a temperature controller configured to execute heating or cooling of the battery cell, based on a preset reference temperature; and a remaining charge obtainer. When the remaining charge is equal to or greater than a predetermined value, the temperature controller sets a heating stop temperature at which the heating is stopped to be higher than a heating stop reference temperature which is the reference temperature at which the heating is stopped, and sets a cooling start temperature at which the cooling is started to be higher than a cooling start reference temperature which is the reference temperature at which the cooling is started.

This application is based on and claims the benefit of priority from Japanese Patent Application No. 2025-059165, filed on 31 Mar. 2025, the content of which is incorporated herein by reference.

### BACKGROUND OF THE INVENTION

### Field of the Invention

The present invention relates to a battery system, a control method for a battery system, and a program.

### Related Art

In recent years, to allow more people to access affordable, reliable, sustainable, and advanced energy, research and development related to secondary batteries that contribute to improvement in efficiency of energy have been conducted.

Conventionally, a technique is known which is for a battery used for a vehicle or the like, obtains information indicating the state of charge of the battery specified by SOC (State of Charge) indicating the state of charge (remaining charge) or the like, and performs battery control related to charge and discharge, temperature and the like. Examples of description of such a technique include Japanese Unexamined Patent Application, Publication No. 2020-149880 and Japanese Unexamined Patent Application, Publication No. 2014-154399.

In Japanese Unexamined Patent Application, Publication No. 2020-149880, adjustment that increases the temperature of the battery if the battery cell has SOC where the battery expands is performed. It is assumed that this can eliminate uneven salt concentration in the electrolyte, and reduce the degradation due to increase in internal resistance during high-rate charging.

In Japanese Unexamined Patent Application, Publication No. 2014-154399, the surface pressure of an electrode assembly that correlates with the state of charge is employed as one control signal, and whether heating is required or not is determined depending on the detected surface pressure. It is assumed that this can reduce the degradation during high-rate charging.
Patent Document 1: Japanese Unexamined Patent Application, Publication No. 2020-149880
Patent Document 2: Japanese Unexamined Patent Application, Publication No. 2014-154399

### SUMMARY OF THE INVENTION

However, for an all-solid-state battery where the interface contact property between the solid electrolyte and another layer is important, and for a battery that employs a Li negative electrode, a Si negative electrode or the like that largely expands, a structure in which an elastic member is provided adjacent to a battery cell has been studied for controlling surface pressure and absorbing expansion amount. Although such a structure allows the surface pressure of the battery cell against the elastic member that expands and contracts depending on the state of charge to change, the conventional art has not been studied from this viewpoint. The change in surface pressure results in change in the thickness of the elastic member, and affects the thermal conductance. Accordingly, the conventional art has room for improvement in view of more accurately controlling the temperature of the battery cell.

The present invention has an object to accurately reflect, in battery cell temperature control, the change in heat transfer characteristics caused by the change in contact surface pressure between the battery cell and the elastic member. It is an object to provide a battery system, a control method for a battery system, and a program that can make the entire system more efficient. This, in turn, contributes to improvement in energy efficiency.
(1) An aspect of the present invention is directed to a battery system (e.g., a battery system 1 described later) including: a battery cell (e.g., a battery cell 21 described later) that expands and contracts depending on a remaining charge; and an elastic member (e.g., an elastic member 22 described later) that is provided adjacent to the battery cell, and has a contact surface pressure against the battery cell that changes depending on expansion and contraction of the battery cell. The battery system includes: a temperature controller (e.g., a temperature controller 37 described later) configured to execute heating or cooling of the battery cell based on a preset reference temperature; and a remaining charge obtainer (e.g., a remaining charge obtainer 33 described later) configured to obtain a state of the remaining charge of the battery cell. When the remaining charge is equal to or greater than a predetermined value, the temperature controller sets a heating stop temperature at which the heating is stopped to be higher than a heating stop reference temperature which is the reference temperature at which the heating is stopped, and sets a cooling start temperature at which the cooling is started to be higher than a cooling start reference temperature which is the reference temperature at which the cooling is started.
(2) Another aspect of the present invention is directed to a battery system (e.g., a battery system 1 described later) including: a battery cell (e.g., a battery cell 21 described later) that expands and contracts depending on a remaining charge; and an elastic member (e.g., an elastic member 22 described later) that is provided adjacent to the battery cell, and has a contact surface pressure against the battery cell that changes depending on expansion and contraction of the battery cell. The battery system includes: a temperature controller (e.g., a temperature controller 37 described later) configured to execute heating or cooling of the battery cell based on a preset reference temperature; and a remaining charge obtainer (e.g., a remaining charge obtainer 33 described later) configured to obtain a state of the remaining charge of the battery cell. When the remaining charge is equal to or less than a predetermined value, the temperature controller sets a heating stop temperature at which the heating is stopped to be lower than a heating stop reference temperature which is the reference temperature at which the heating is stopped, and sets a cooling start temperature at which the cooling is started to be lower than a cooling start reference temperature which is the reference temperature at which the cooling is started.
(3) Another aspect of the present invention is directed to a battery system (e.g., a battery system 1 described later) including: a battery cell (e.g., a battery cell 21 described later) that expands and contracts depending on a remaining charge; and an elastic member (e.g., an elastic member 22 described later) that is provided adjacent to the battery cell, and has a contact surface pressure against the battery cell that changes depending on expansion and contraction of the battery cell. The battery system includes: a temperature adjuster (e.g., a liquid deliverer 11, a heater device 12, an airflow rate adjuster 13, and a heat exhauster 16 described later); a temperature controller (e.g., temperature controller 37 described later) configured to execute heating or cooling of the battery cell based on a preset reference capability of the temperature adjuster; and a remaining charge obtainer (e.g., a remaining charge obtainer 33 described later) configured to obtain a state of the remaining charge of the battery cell. When the remaining charge is equal to or greater than a predetermined value, the temperature controller sets a heating capability of the temperature adjuster to be higher than a heating reference capability which is the reference capability for the heating, and sets a cooling capability of the temperature adjuster to be lower than a cooling reference capability which is the reference capability for the cooling.
(4) Another aspect of the present invention is directed to a battery system (e.g., a battery system 1 described later) including: a battery cell (e.g., a battery cell 21 described later) that expands and contracts depending on a remaining charge; and an elastic member (e.g., an elastic member 22 described later) that is provided adjacent to the battery cell, and has a contact surface pressure against the battery cell that changes depending on expansion and contraction of the battery cell. The battery system includes: a temperature adjuster (e.g., a liquid deliverer 11, a heater device 12, an airflow rate adjuster 13, and a heat exhauster 16 described later); a temperature controller (e.g., a temperature controller 37 described later) configured to execute heating or cooling of the battery cell based on a preset reference capability of the temperature adjuster; and a remaining charge obtainer (e.g., a remaining charge obtainer 33 described later) configured to obtain a state of the remaining charge of the battery cell. When the remaining charge is equal to or less than a predetermined value, the temperature controller sets a heating capability of the temperature adjuster to be lower than a heating reference capability which is the reference capability for the heating, and sets a cooling capability of the temperature adjuster to be higher than a cooling reference capability which is the reference capability for the cooling.
(5) In the battery system according to (1) or (2) described above, the temperature controller may determine which region among a plurality of preset regions the remaining charge belongs to, and set the heating stop temperature and the cooling start temperature based on a result of the determination.
(6) The battery system according to (1) or (2) described above may further include a surface pressure obtainer (e.g., a surface pressure obtainer 35 described later) configured to obtain a contact surface pressure between the battery cell and the elastic member, and the temperature controller may set the heating stop temperature and the cooling start temperature, based on the contact surface pressure.
(7) In the battery system according to (3) or (4) described above, the temperature controller may determine which region among a plurality of preset regions the remaining charge belongs to, and set the heating capability and the cooling capability based on a result of the determination.
(8) The battery system according to (3) or (4) described above may further include a surface pressure obtainer (e.g., a surface pressure obtainer 35 described later) configured to obtain a contact surface pressure between the battery cell and the elastic member, and the temperature controller may set the heating capability and the cooling capability based on the contact surface pressure.
(9) The battery system according to (1) or (2) described above may further include a vehicle state obtainer (e.g., a vehicle state obtainer 36 described later) configured to obtain a vehicle state, and the temperature controller may set the heating stop temperature and the cooling start temperature based on the vehicle state.
(10) The battery system according to (3) or (4) described above may further include a vehicle state obtainer (e.g., a vehicle state obtainer 36 described later) configured to obtain a vehicle state, and the temperature controller sets the heating capability and the cooling capability based on the vehicle state.
(11) In the battery system according to (3) or (4) described above, the temperature adjuster may include a liquid deliverer (e.g., a liquid deliverer 11 described later) configured to control a flow rate of a thermal medium that is to be supplied to the battery cell, and the temperature controller may change the flow rate of the thermal medium controlled by the liquid deliverer based on the remaining charge.
(12) In the battery system according to (3) or (4) described above, the temperature adjuster may include a heat exhauster (e.g., a heat exhauster 16 described later) configured to cool a thermal medium that is supplied to the battery cell, and the temperature controller may change a cooling setting for the heat exhauster based on the remaining charge.
(13) In the battery system according to (3) or (4) described above, the temperature adjuster may include a heater (e.g., a heater device 12 described later) configured to heat a thermal medium that is supplied to the battery cell, and the temperature controller may change a heating setting for the heater based on the remaining charge.
(14) In the battery system according to (3) or (4) described above, the temperature adjuster may include: a heat exhauster (e.g., a heat exhauster 16 described later) provided in a circuit through which a thermal medium to be supplied to the battery cell circulates; and an airflow rate adjuster (e.g., an airflow rate adjuster 13 described later) capable of adjusting an airflow rate that is to be supplied to the heat exhauster, and the temperature controller may control the airflow rate adjuster based on the remaining charge.
(15) In the battery system according to any one of (1) to (14) described above, the battery cell may be an all-solid-state battery cell.
(16) In the battery system according to any one of (1) to (15) described above, a negative electrode of the battery cell may contain Li metal or Li alloy.
(17) In the battery system according to any one of (1) to (15) described above, a negative electrode of the battery cell may contain Si or Si alloy.
(18) Another aspect of the present invention is directed to a control method for a battery system (e.g., a battery system 1 described later) including: a battery cell (e.g., a battery cell 21 described later) that expands and contracts depending on a remaining charge; and an elastic member (e.g., an elastic member 22 described later) that is provided adjacent to the battery cell, and has a contact surface pressure against the battery cell that changes depending on expansion and contraction of the battery cell. The control method includes: a temperature control step of executing heating or cooling of the battery cell based on a preset reference temperature; and a remaining charge obtaining step of obtaining a state of the remaining charge of the battery cell. When the remaining charge is equal to or greater than a predetermined value, the temperature control step further includes setting a heating stop temperature at which the heating is stopped to be higher than a heating stop reference temperature which is the reference temperature at which the heating is stopped, and setting a cooling start temperature at which the cooling is started to be higher than a cooling start reference temperature which is the reference temperature at which the cooling is started.
(19) Another aspect of the present invention is directed to a control method for a battery system (e.g., a battery system 1 described later) including: a battery cell (e.g., a battery cell 21 described later) that expands and contracts depending on a remaining charge; and an elastic member (e.g., an elastic member 22 described later) that is provided adjacent to the battery cell, and has a contact surface pressure against the battery cell that changes depending on expansion and contraction of the battery cell. The control method includes: a temperature control step of executing heating or cooling of the battery cell based on a preset reference temperature; and a remaining charge obtaining step of obtaining a state of the remaining charge of the battery cell. When the remaining charge is equal to or less than a predetermined value, the temperature control step further includes setting a heating stop temperature at which the heating is stopped to be lower than a heating stop reference temperature which is the reference temperature at which the heating is stopped, and setting a cooling start temperature at which the cooling is started to be lower than a cooling start reference temperature which is the reference temperature at which the cooling is started.
(20) Another aspect of the present invention is directed to a control method for a battery system (e.g., a battery system 1 described later) including: a battery cell (e.g., a battery cell 21 described later) that expands and contracts depending on a remaining charge; an elastic member (e.g., an elastic member 22 described later) that is provided adjacent to the battery cell, and has a contact surface pressure against the battery cell that changes depending on expansion and contraction of the battery cell; and a temperature adjuster (e.g., a liquid deliverer 11, a heater device 12, an airflow rate adjuster 13, and a heat exhauster 16 described later). The control method includes: a temperature control step of executing heating or cooling of the battery cell based on a preset reference capability of the temperature adjuster; and a remaining charge obtaining step of obtaining a state of the remaining charge of the battery cell When the remaining charge is equal to or greater than a predetermined value, the temperature control step further includes setting a heating capability of the temperature adjuster to be higher than a heating reference capability which is the reference capability for the heating, and setting a cooling capability of the temperature adjuster to be lower than a cooling reference capability which is the reference capability for the cooling.
(21) Another aspect of the present invention is directed to a control method for a battery system (e.g., a battery system 1 described later) including: a battery cell (e.g., a battery cell 21 described later) that expands and contracts depending on a remaining charge; an elastic member (e.g., an elastic member 22 described later) that is provided adjacent to the battery cell, and has a contact surface pressure against the battery cell that changes depending on expansion and contraction of the battery cell; and a temperature adjuster (e.g., a liquid deliverer 11, a heater device 12, an airflow rate adjuster 13, and a heat exhauster 16 described later). The control method includes: a temperature control step of executing heating or cooling of the battery cell based on a preset reference capability of the temperature adjuster; and a remaining charge obtaining step of obtaining a state of the remaining charge of the battery cell. When the remaining charge is equal to or less than a predetermined value, the temperature control step further includes setting a heating capability of the temperature adjuster to be lower than a heating reference capability which is the reference capability for the heating, and setting a cooling capability of the temperature adjuster to be higher than a cooling reference capability which is the reference capability for the cooling.
(22) Another aspect of the present invention is directed to a program for causing a computer to execute a control method for a battery system (e.g., a battery system 1 described later) including: a battery cell (e.g., a battery cell 21 described later) that expands and contracts depending on a remaining charge; and an elastic member (e.g., an elastic member 22 described later) that is provided adjacent to the battery cell, and has a contact surface pressure against the battery cell that changes depending on expansion and contraction of the battery cell the program includes: a temperature control step of executing heating or cooling of the battery cell, based on a preset reference temperature; and a remaining charge obtaining step of obtaining a state of the remaining charge of the battery cell. When the remaining charge is equal to or greater than a predetermined value, the temperature control step further includes setting a heating stop temperature at which the heating is stopped to be higher than a heating stop reference temperature which is the reference temperature at which the heating is stopped, and setting a cooling start temperature at which the cooling is started to be higher than a cooling start reference temperature which is the reference temperature at which the cooling is started.
(23) Another aspect of the present invention is directed to a program for causing a computer to execute a control method for a battery system (e.g., a battery system 1 described later) including: a battery cell (e.g., a battery cell 21 described later) that expands and contracts depending on a remaining charge; and an elastic member (e.g., an elastic member 22 described later) that is provided adjacent to the battery cell, and has a contact surface pressure against the battery cell that changes depending on expansion and contraction of the battery cell. The program includes: a temperature control step of executing heating or cooling of the battery cell based on a preset reference temperature; and a remaining charge obtaining step of obtaining a state of the remaining charge of the battery cell. When the remaining charge is equal to or less than a predetermined value, the temperature control step further include setting a heating stop temperature at which the heating is stopped to be lower than a heating stop reference temperature which is the reference temperature at which the heating is stopped, and setting a cooling start temperature at which the cooling is started to be lower than a cooling start reference temperature which is the reference temperature at which the cooling is started.
(24) Another aspect of the present invention is directed to a program for causing a computer to execute a control method for a battery system (e.g., a battery system 1 described later) including: a battery cell (e.g., a battery cell 21 described later) that expands and contracts depending on a remaining charge; an elastic member (e.g., an elastic member 22 described later) that is provided adjacent to the battery cell, and has a contact surface pressure against the battery cell that changes depending on expansion and contraction of the battery cell; and a temperature adjuster (e.g., a liquid deliverer 11, a heater device 12, an airflow rate adjuster 13, and a heat exhauster 16 described later). The program includes: a temperature control step of executing heating or cooling of the battery cell based on a preset reference capability of the temperature adjuster; and a remaining charge obtaining step of obtaining a state of the remaining charge of the battery cell. When the remaining charge is equal to or greater than a predetermined value, the temperature control step further includes setting a heating capability of the temperature adjuster to be higher than a heating reference capability that is the reference capability for the heating, and setting a cooling capability of the temperature adjuster to be lower than a cooling reference capability that is the reference capability for the cooling.
(25) Another aspect of the present invention is directed to a program for causing a computer to execute a control method for a battery system (e.g., a battery system 1 described later) including: a battery cell (e.g., a battery cell 21 described later) that expands and contracts depending on a remaining charge; an elastic member (e.g., an elastic member 22 described later) that is provided adjacent to the battery cell, and has a contact surface pressure against the battery cell that changes depending on expansion and contraction of the battery cell; and a temperature adjuster (e.g., a liquid deliverer 11, a heater device 12, an airflow rate adjuster 13, and a heat exhauster 16 described later). the program includes: a temperature control step of executing heating or cooling of the battery cell based on a preset reference capability of the temperature adjuster; and a remaining charge obtaining step of obtaining a state of the remaining charge of the battery cell. When the remaining charge is equal to or less than a predetermined value, the temperature control step further includes setting a heating capability of the temperature adjuster to be lower than a heating reference capability that is the reference capability for the heating, and setting a cooling capability of the temperature adjuster to be higher than a cooling reference capability that is the reference capability for the cooling.

The present invention can provide a battery system, a control method for a battery system, and a program that result in an improvement in the efficiency of the entire system by accurately reflecting, in battery cell temperature control, the change in heat transfer characteristics caused by the change in contact surface pressure between the battery cell and the elastic member.

### BRIEF DESCRIPTION OF THE DRAWINGS

FIG. 1 is a block diagram of a vehicle that includes a battery system to which a battery ECU is applied according to one embodiment of the present invention;

FIG. 2 shows a cold water circuit of the battery system according to the present embodiment;

FIG. 3 schematically shows a battery pack of the battery system according to the present embodiment;

FIG. 4 is a graph showing the relationship between the charge of the battery cell and the surface pressure applied to a battery cell during charging and discharging in the battery pack of the battery system according to the present embodiment;

FIG. 5 is a graph showing an example of the thermal conductivity of an elastic member;

FIG. 6 is a graph showing an example of the thermal conductance between the battery cell and the elastic member;

FIG. 7 is a graph showing an example of a current profile where the current value gradually decreases over time;

FIG. 8 is a graph showing the comparison of the temperature distribution of the battery cell between a low SOC case and a high SOC case at elapsed time t1 under applied current in FIG. 7;

FIG. 9 is a graph showing the comparison of the temperature distribution of the battery cell between the low SOC case and the high SOC case at elapsed time t2 under applied current in FIG. 7;

FIG. 10 shows a heating stop temperature and a cooling start temperature that are set depending on the SOC;

FIG. 11 shows the relationship between the SOC, and the heating stop temperature and the cooling start temperature;

FIG. 12 is a flowchart showing an example of the flow of a process of setting a heating temperature range and a cooling temperature range based on the SOC;

FIG. 13 is a flowchart showing another example of the flow of the process of setting the heating temperature range and the cooling temperature range based on the SOC;

FIG. 14 is a graph showing the comparison of the battery cell with the temperature distribution between a case of setting a reference cooling capability and a case of setting an enhanced cooling capability at elapsed time t1 under applied current in FIG. 7;

FIG. 15 is a graph showing the comparison of the battery cell with the temperature distribution between the case of setting the reference cooling capability and the case of setting the enhanced cooling capability at elapsed time t2 under applied current in FIG. 7;

FIG. 16 is a flowchart showing an example of the flow of a process of setting a heating capability and a cooling capability based on the SOC;

FIG. 17 is a flowchart showing another example of the flow of the process of setting the heating capability and the cooling capability based on the SOC; and

FIG. 18 shows a cold water circuit of a battery system according to a modified example.

### DETAILED DESCRIPTION OF THE INVENTION

A battery system 1, a control method for the battery system 1, and a program according to one embodiment of the present invention are described below with reference to the drawings.

### Entire Configuration

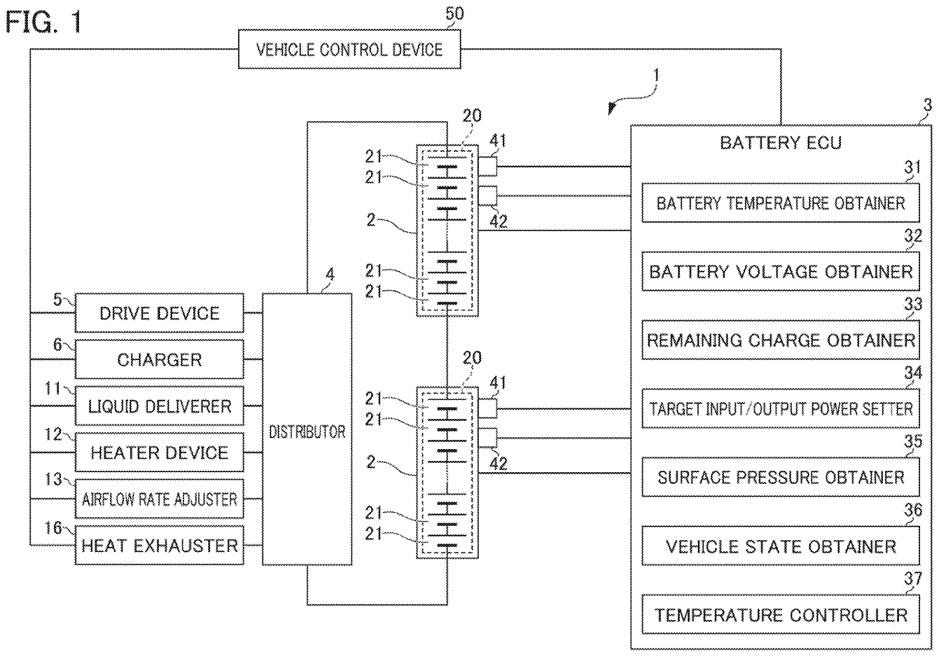

FIG. 1 is a block diagram of a vehicle that includes a battery system 1 to which a battery ECU 3 is applied according to one embodiment of the present invention. As shown in FIG. 1, the battery system 1 includes: two battery packs 2 that are coupled in series; and a battery ECU (Electronic Control Unit) 3. The battery ECU 3 includes a CPU and a memory. The function and operation of each function unit described later are achieved by cooperation of these CPU and memory, and a program stored in the memory. Note that the configuration of the battery system 1, such as the number and connection method of the battery packs 2, is not limited to the configuration shown in FIG. 1.

Each battery pack 2 is a unit of a secondary battery that includes a plurality of battery cells 21. A battery temperature sensor 41 that detects the temperature of the battery pack 2, and a battery voltage sensor 42 that detects the input/output voltage of the battery pack 2 are attached to each battery pack 2. Each battery temperature sensor 41 and each battery voltage sensor 42 are coupled to the battery ECU 3. Each battery temperature sensor 41 and each battery voltage sensor 42 output detected signals to the battery ECU 3.

A distributor 4 is coupled to the battery packs 2. The distributor 4 is coupled to the battery packs 2, and also coupled to a drive device 5 mounted on the vehicle, a charger 6, a liquid deliverer 11, a heater device 12, an airflow rate adjuster 13 such as an AGS (Active Grille Shutter), and auxiliary equipment such as a heat exhauster 16. The drive device 5 includes, for example, a vehicle-driving electric motor that drives the vehicle. The vehicle travels by the power of the electric motor. The charger 6 includes a power conversion device that accepts AC power from a power supply device, not shown, outside the vehicle, and converts the power into DC power at a predetermined voltage. The battery pack 2 can be charged with the power that have been from the power supply device outside of the vehicle and converted by the charger 6.

The auxiliary equipment, such as a temperature adjuster that includes the liquid deliverer 11, the heater device 12, the airflow rate adjuster 13, and the heat exhauster 16 can operate on power supplied from the battery pack 2.

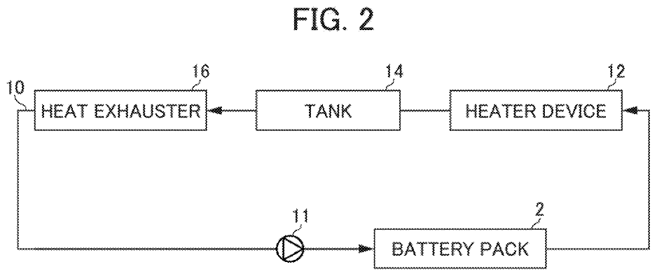

FIG. 2 shows a cold water circuit 10 of the battery system 1 according to the present embodiment. The liquid deliverer 11, the battery pack 2, the heater device 12, a tank 14, and the heat exhauster 16 are provided on the cold water circuit 10 shown in FIG. 2.

The liquid deliverer 11 is an electric water pump (EWP) that delivers a thermal medium that circulates through the cold water circuit 10. The heater device 12 is a heat supplying heater that heats the thermal medium, and is an electric heater (ECH) that operates on electricity. The heater device 12 may be used as, for example, a heater for air conditioning in the vehicle.

The tank 14 is a retaining device that retains the thermal medium. The heat exhauster 16 is a cooler that cools the thermal medium, and is, for example, a radiator that includes the airflow rate adjuster 13, such as an AGS. The airflow rate adjuster 13, such as an AGS, is a shutter device provided at a position where air is delivered to the radiator, and can adjust the airflow rate delivered to the heat exhauster 16, such as the radiator, by opening and closing this shutter device. By closing the airflow rate adjuster 13, such as an AGS, the cooling capability of the heat exhauster 16, such as the radiator, can be reduced. This can improve the electric cost by avoiding unnecessary cooling, and can make the entire system more efficient.

The heat exhauster 16 may be a coolant water circulation device that includes a compressor, an evaporator, a condenser, an expansion valve and the like, as main components. In this case, the heat exhauster 16 can control the cooling capability by, for example, adjusting the rotation speed of the compressor.

Note that the cold water circuit 10 in FIG. 2 is an example of a configuration for cooling the battery pack 2, and is not limited to the configuration in FIG. 2. For example, in a case where the battery cell 21 is an all-solid-state battery, the temperature range in which the all-solid-state battery can be used is wider than that for a battery that contains electrolyte. Accordingly, a configuration that includes no heat exhauster 16 in the cold water circuit 10 may be employed.

Returning to FIG. 1, the battery ECU 3 is described. The battery ECU 3 is coupled to each battery pack 2. The battery ECU 3 controls the charging/discharging power for the battery pack 2. The battery ECU 3 is coupled to a vehicle control device 50. The vehicle control device 50 includes a plurality of ECUs, and performs vehicle drive control, various types of control for the auxiliary equipment (the temperature adjuster or the like that includes the liquid deliverer 11, the heater device 12, the airflow rate adjuster 13, and the heat exhauster 16) and the like. The vehicle control device 50 outputs, to the battery ECU 3, signals related to the control of the battery packs 2.

The battery ECU 3 in the present embodiment is a battery control device that includes a battery temperature obtainer 31, a battery voltage obtainer 32, a remaining charge obtainer 33, a target input/output power setter 34, a surface pressure obtainer 35, a vehicle state obtainer 36, and a temperature controller 37.

The battery temperature obtainer 31 obtains the temperature of each battery pack 2, based on the detected signal output from the corresponding battery temperature sensor 41.

The battery voltage obtainer 32 obtains the input/output voltage of each battery pack 2, based on the detected signal output from the corresponding battery voltage sensor 42.

The remaining charge obtainer 33 obtains the SOC (State of Charge) that indicates the state of the remaining charge of each battery pack 2 (battery cell 21), based on the temperature of the corresponding battery pack 2 obtained by the battery temperature obtainer 31 and on the input/output voltage of the corresponding battery pack 2 obtained by the battery voltage obtainer 32.

The target input/output power setter 34 sets the target input/output power of each battery pack 2, based on the signal related to the control of the corresponding battery pack 2 output from the vehicle control device 50. The target input/output power setter 34 outputs a signal that indicates the set target input/output power to the battery pack 2, and performs control such that the input/output power of the battery pack 2 can be the set target input/output power.

The surface pressure obtainer 35 obtains the contact surface pressure between the battery cell 21 and the elastic member 22, based on, for example, a detected signal output from a pressure sensor, not shown, provided in each battery pack 2.

The vehicle state obtainer 36 obtains a vehicle state signal that indicates the state of the vehicle, from the vehicle control device 50. The state of the vehicle is information that indicates the vehicle operation state such as whether the coupling to the power supply device is present or not and whether the vehicle is traveling or not.

The temperature controller 37 executes temperature control for heating or cooling each battery cell 21, based on a preset reference temperature for the corresponding battery cell 21. Preferably, the temperature controller 37 performs the temperature control for each battery pack 2, based on the SOC that indicates the remaining charge calculated by the remaining charge obtainer 33. The temperature controller 37 may execute the temperature control for each battery pack 2, based on the vehicle state obtained by the vehicle state obtainer 36. The temperature controller 37 may execute the temperature control for each battery pack 2, based on the contact surface pressure between the battery cell 21 and the elastic member 22 obtained by the surface pressure obtainer 35. The details of the temperature control of the temperature controller 37 are described later.

### Module Structure of Battery Pack 2

Each battery module 20 includes at least battery cells 21 that expand and contract depending on charging and discharging, and elastic members 22 for the sake of securing the surface pressure. The battery module 20 in the present embodiment is a structure assembly where the temperature tendency of each battery cell 21 changes depending on the change in the thermal conductance between the battery cell 21 and the elastic member 22. The details are described later.

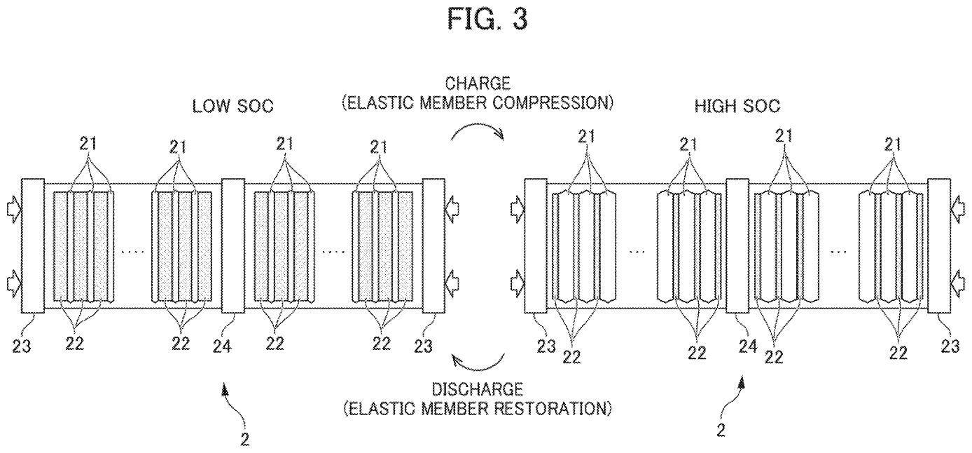

Next, referring to FIG. 3, the structure of the battery module 20 in each battery pack 2 is described. FIG. 3 schematically shows the battery pack 2 of the battery system 1 according to the present embodiment. As shown in FIG. 3, the battery module 20 in the present embodiment includes the battery cells 21, the elastic members 22, endplates 23, and a center plate 24. The battery module 20 may include, a binding bar, a gap filler, and a water jacket, which are not shown. Note that the center plate 24 is not an essential component. The center plate 24 is not necessarily included.

The battery cell 21 is, for example, a secondary battery where a solid material is used as at least part of electrolyte. The battery cell 21 may be an all-solid-state battery that uses only a solid electrolyte as the electrolyte, or a semi-solid-state battery. The battery cell 21 may be, for example, a gel-polymer semi-solid-state battery where the electrolyte contains polymer gel, or a clay semi-solid-state battery that uses a clay (clay-like) material that contains positive/negative electrode materials into which an electrolyte is mixed. Alternatively, the battery cell 21 may be a liquid-containing semi-solid-state battery where a small amount of a fluid liquid material or a flexible gel-polymer is added to a solid electrolyte. The negative electrode of the battery cell 21 in the present embodiment may be Li metal or Li alloy that contains Li. The negative electrode of the battery cell 21 in the present embodiment may be Si or Si alloy that contains Si. In the case where the battery cell 21 is an all-solid-state battery, the negative electrode made up of a material other than them may be employed.

The battery pack 2 in the present embodiment may have a configuration where multiple layers of square or laminate battery cells 21 are stacked in a first direction. The battery cell 21 has a predetermined thickness in the first direction, and the surface perpendicular to the first direction has a substantially planar shape.

The elastic members 22 are provided between the battery cells 21 stacked in the first direction in an alternating manner. The elastic members 22 are binding members that bind the battery cells 21, and are each interposed between the adjacent battery cells 21 in the first direction, which are thus filled therewith.

The endplates 23 are provided one side (left on the sheet) and the other side (right on the sheet) in the first direction of the aggregation of the stacked battery cells 21. The aggregation of the stacked battery cells 21 is in a state of being interposed between the pair of endplates 23 in the first direction. The elastic member 22 is provided to face the surface on the other side in the first direction of the endplate 23 on the one side in the first direction. The elastic member 22 is provided to face the surface on the one side in the first direction of the endplate 23 on the other side in the first direction.

The center plate 24 is provided at the center in the first direction of the aggregation of the stacked battery cells 21. The elastic member 22 is provided to face each of the surfaces on the opposite sides in the first direction of the center plate 24.

### Rlationship Between Battery Binding Technique and Thermal Conductance Dependence

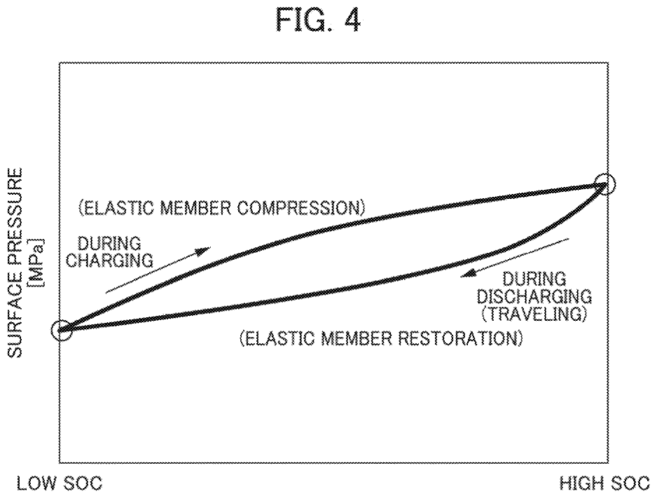

Next, the battery binding technology and the thermal conductance dependence are described with reference to FIGS. 3 and 4. FIG. 3 shows an image of the change in shape of the elastic member 22 due to charging and discharging. FIG. 4 is a graph showing the relationship between the charge of the battery cell 21 and the surface pressure applied to the battery cell 21 during charging and discharging in the battery pack 2 of the battery system 1 according to the present embodiment. The ordinate axis in the graph in FIG. 4 indicates the surface pressure of the battery cell 21, and the abscissa axis indicates the charge of the battery cell 21.

As shown in FIG. 3, as the SOC indicating the remaining charge increases due to charging, the battery pack 2 comes into a state where the battery cells 21 expand, and the elastic members 22 are compressed. As the SOC decreases due to discharging, the battery pack 2 comes into a state where the battery cells 21 contract, and the elastic members 22 are restored from the compressed state.

As shown in FIG. 4, during charging of the battery pack 2, as the remaining charge of each battery cell 21 increases, the surface pressure applied to the battery cell 21 increases along an upwardly convex curve. On the other hand, during discharging of the battery pack 2, as the remaining charge of the battery cell 21 decreases, the surface pressure applied to the battery cell 21 decreases along a downwardly convex curve. As described above, the relationship between the remaining charge of the battery cell 21 and the surface pressure applied to the battery cell 21 exhibits hysteresis characteristics during charging and discharging.

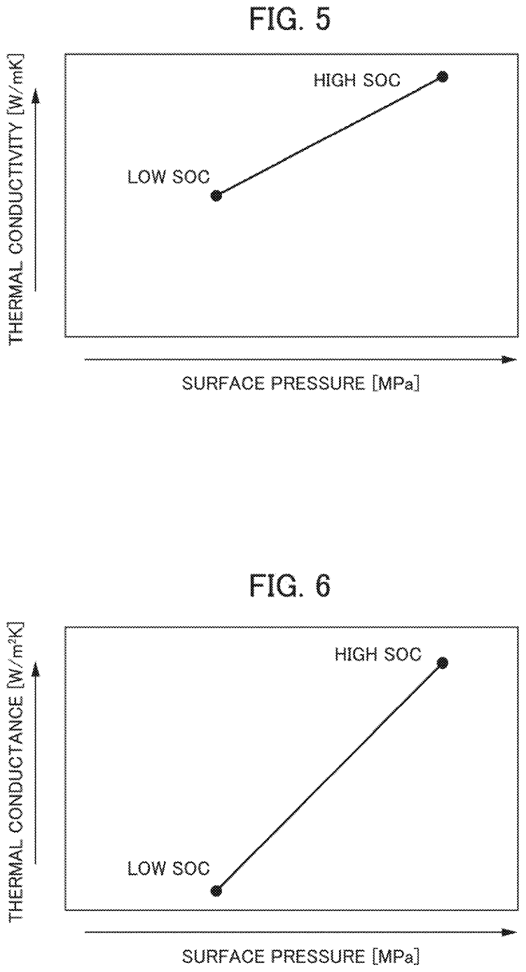

Next, referring to FIGS. 5 and 6, the relationships between the surface pressure, and the thermal conductivity and the thermal conductance are described. FIG. 5 is a graph showing an example of the thermal conductivity of the elastic member 22. The ordinate axis of the graph in FIG. 5 indicates the thermal conductivity [W/mK], and the abscissa axis indicates the surface pressure [MPa]. FIG. 6 is a graph showing an example of the thermal conductance between the battery cell 21 and the elastic member 22. The ordinate axis of the graph in FIG. 6 indicates the thermal conductance [W/m²K], and the abscissa axis indicates the surface pressure [MPa].

As shown in FIGS. 5 and 6, according to the structure of binding the battery cell 21, it is shown that as the surface pressure [MPa] that affects the thickness of the elastic member 22 increases, the thickness of the elastic member 22 decreases, and the thermal conductivity [W/mK] of the elastic member 22 and the thermal conductance [W/m²K] between the battery cell 21 and the elastic member 22 increase.

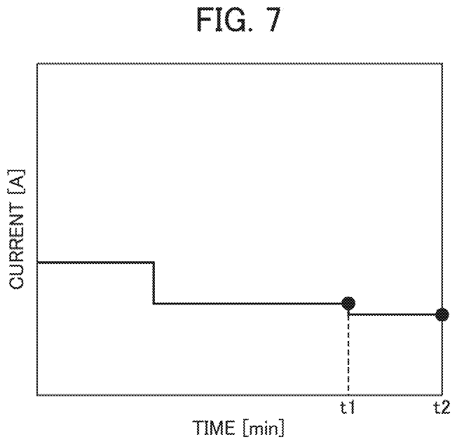

Next, the difference in battery temperature between the low SOC and the high SOC is described. FIG. 7 is a graph showing an example of a current profile where the current value gradually decreases over time. In the graph in FIG. 7, the ordinate axis indicates current [A], and the abscissa axis indicates time [min]. As shown in FIG. 7, the value of current gradually decreases over time.

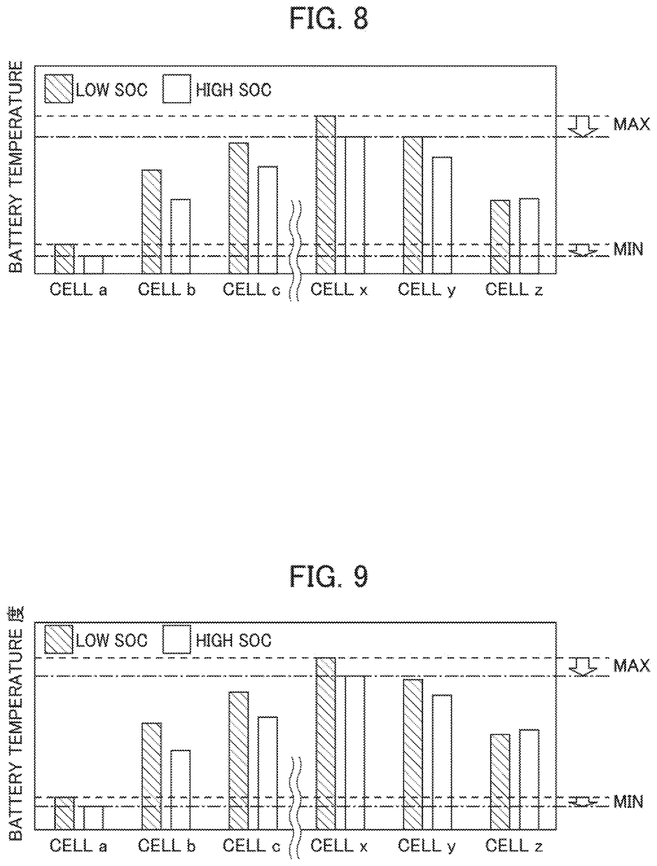

FIG. 8 is a graph showing the comparison of the temperature distribution of the battery cell 21 between the low SOC case and the high SOC case at elapsed time t1 under applied current in FIG. 7. FIG. 9 is a graph showing the comparison of the temperature distribution of the battery cell 21 between the low SOC case and the high SOC case at elapsed time t2 under applied current in FIG. 7. Both the graphs in FIGS. 8 and 9 indicate the temperature in the case where the state of the battery cells 21 in the battery pack 2 is the low SOC, and the temperature in the high SOC case. Cells a, b, c, . . . , x, y, z are stacked and provided in this order along the first direction of the battery module 20 with the elastic members 22 being interposed in an alternating manner, thus constituting the respective battery cells 21 in the battery module 20. As for the battery module 20, the cells a to z are provided symmetrically with respect to the center plate 24. That is, the cells z are provided on the opposite sides of the center plate 24 with the corresponding elastic member 22 being interposed.

As shown in FIGS. 8 and 9, it is exhibited that in both cases at elapsed time t1 and elapsed time t2, both the highest temperature and the lowest temperature are low temperatures in the state of the battery pack 2 that is the high SOC. In the battery module 20, the thermal conductance between the battery cell 21 and the elastic member 22 decreases in the low SOC, and the temperature of the battery cell 21 resultantly increases. On the other hand, in the battery module 20, the thermal conductance between the battery cell 21 and the elastic member 22 increases in the high SOC, the temperature of the battery cell 21 resultantly decreases.

As described above, it is shown that the SOC of the battery pack 2 affects the temperature of the battery cell 21. Accordingly, the present embodiment employs a configuration of adjusting the temperature in a manner where the SOC of the battery pack 2 is reflected.

### First Control Mode

### <Setting of Heating Stop Temperature and Cooling Start Temperature>

First, a first control mode of the temperature controller 37 where a heating stop temperature and a cooling start temperature are changed depending on the SOC of the battery pack 2 is described. The first control mode is for thermal management control of increasing the heating stop temperature and the cooling start temperature as the low SOC transitions to the high SOC in accordance with the characteristics of variation in thermal conductance between the battery cell 21 and the elastic member 22 depending on the SOC of the battery.

Specifically, since there is a tendency that the thermal conductance between the battery cell 21 and the elastic member 22 increases and the temperature of the battery cell 21 decreases if the SOC is higher than or equal to a predetermined SOC, in the first control mode the temperature controller 37 sets the heating stop temperature higher than a heating stop reference temperature that is a reference temperature for stopping heating, and sets the cooling start temperature higher than a cooling start reference temperature that is a reference temperature for starting cooling.

Since there is a tendency that the thermal conductance between the battery cell 21 and the elastic member 22 decreases and the temperature of the battery cell 21 increases if the SOC is lower than or equal to a predetermined SOC that is different from the predetermined SOC described above, in the first control mode the temperature controller 37 sets the heating stop temperature lower than the heating stop reference temperature, and sets the cooling start temperature lower than the cooling start reference temperature.

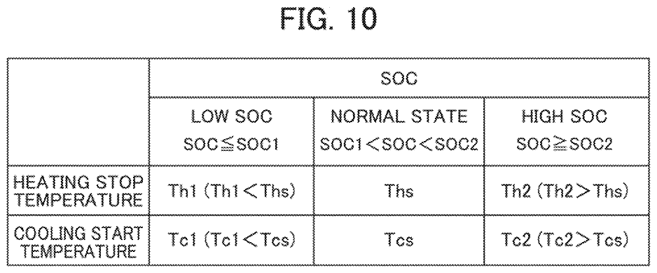

As described above, the heating stop temperature and the cooling start temperature are set depending on the SOC. Referring to FIG. 10, the heating stop temperature and the cooling start temperature that are set depending on the SOC are described. FIG. 10 shows the heating stop temperature and the cooling start temperature that are set depending on the SOC.

Preferably, the SOC is classified into a plurality of regions. The number of classified regions is not specifically limited. In the example in FIG. 10, the SOC is classified into three regions that are a low SOC, a normal state, and a high SOC. For example, if the SOC is lower than or equal to a first threshold SOC1 (SOC≤SOC1), the SOC is determined as the low SOC. If the SOC is higher than or equal to a second threshold SOC2 that is higher than the first threshold SOC1 (SOC≥SOC2), the SOC is determined as the high SOC. If the SOC is higher than the first threshold SOC1 and lower than the second threshold SOC2 (SOC1<SOC<SOC2), the SOC is determined as the normal state. The first threshold SOC1 and the second threshold SOC2 are set to arbitrarily selected values depending on the battery characteristics.

As shown in FIG. 10, if the SOC is the normal state, a heating stop reference temperature Ths and a cooling start reference temperature Tcs that are reference temperatures preset depending on the vehicle state are set as they are, without any change. Specifically, based on the vehicle state obtained by the vehicle state obtainer 36, the heating stop reference temperature Ths is set as the heating stop temperature, and the cooling start reference temperature Tcs is set as the cooling start temperature.

On the other hand, in the case of the low SOC, the heating stop temperature is set to Th1, and the cooling start temperature is set to Tc1. In the low SOC, the thermal conductance between the battery cell 21 and the elastic member 22 decreases, and the temperature of the battery cell 21 increases. Accordingly, the heating stop temperature Th1 is set to a temperature lower than the heating stop reference temperature Ths, which is the reference temperature. Likewise, the cooling start temperature Tc1 is set to a temperature lower than the cooling start reference temperature Tcs, which is the reference temperature.

In the case of the high SOC, the heating stop temperature is set to Th2, and the cooling start temperature is set to Tc2. In the high SOC, the thermal conductance between the battery cell 21 and the elastic member 22 increases, and the temperature of the battery cell 21 decreases. Accordingly, the heating stop temperature Th2 is set to a temperature higher than the heating stop reference temperature Ths, which is the reference temperature. Likewise, the cooling start temperature Tc2 is set to a temperature higher than the cooling start reference temperature Tcs, which is the reference temperature.

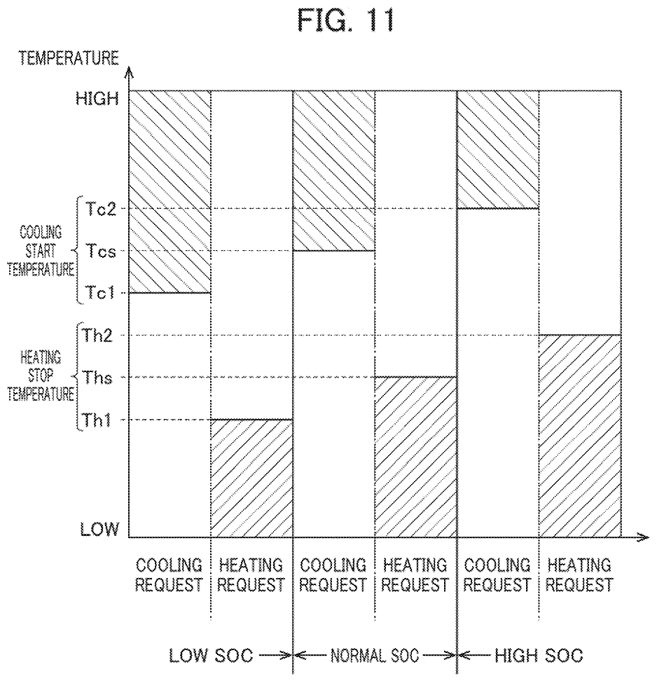

FIG. 11 shows the relationship between the SOC, and the heating stop temperature and the cooling start temperature. As apparent also from FIG. 11, the heating stop temperature and the cooling start temperature are set higher as the SOC increases. This also applies not only to the case where the vehicle state is traveling but also to other vehicle states. For example, even when the vehicle state is a left (after travel), charging (normal charging), charging (fast charging), left (after charging), or heat retention state, similar control is performed. That is, in the low SOC, the heating stop temperature and the cooling start temperature are set lower by a predetermined temperature than the reference temperature in the normal state. In contrast, in the high SOC, the heating stop temperature and the cooling start temperature are set higher by a predetermined temperature than the reference temperature in the normal state. Note that the level of the predetermined temperature is set depending on the battery characteristics, the level of the predetermined temperature may be different between the heating stop temperature and the cooling start temperature, and the level of the predetermined temperature may be different between the low SOC and the high SOC.

### <Flow of Process in First Control Mode>

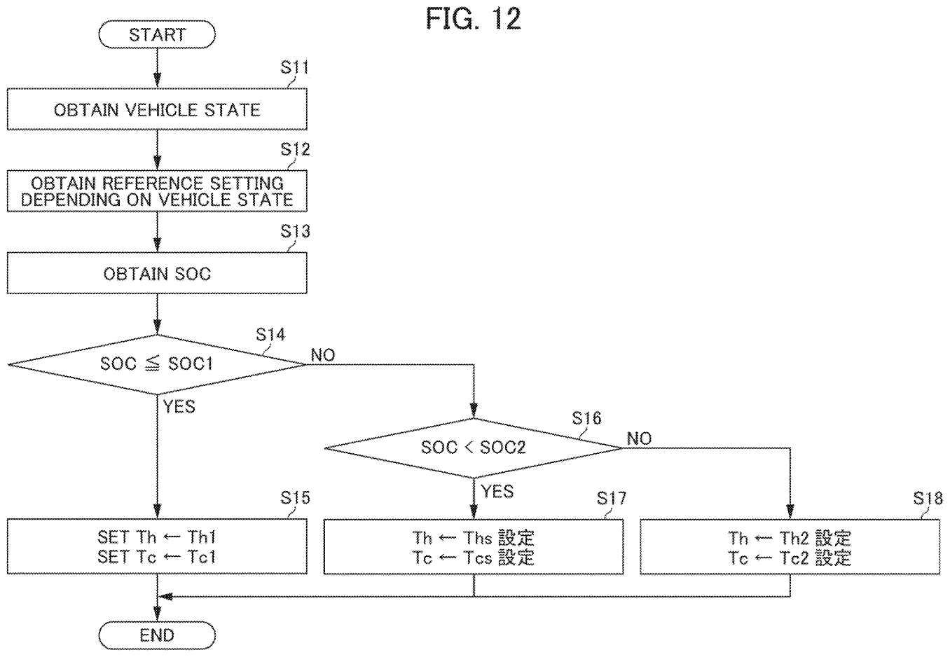

Next, referring to FIG. 12, the flow of a process of setting the heating temperature range and the cooling temperature range is described. FIG. 12 is a flowchart showing an example of the flow of the process of setting a heating temperature range and a cooling temperature range based on the SOC.

In Step S11, the vehicle state obtainer 36 obtains the vehicle state signal from the vehicle control device 50.

In Step S12, the temperature controller 37 obtains reference setting (reference temperature) preset depending on the vehicle state. Specifically, the temperature controller 37 obtains the heating stop reference temperature Ths and the cooling start reference temperature Tcs as reference temperatures.

In Step S13, the remaining charge obtainer 33 obtains the SOC that indicates the state of charge of the battery pack 2 (battery cells 21).

In Step S14, the temperature controller 37 determines whether or not the obtained SOC value is lower than or equal to the first threshold SOC1. If the SOC value is lower than or equal to the first threshold SOC1, i.e., in the low SOC, the processing proceeds to Step S15 (Step S14: YES). If the SOC value is not lower than or equal to the first threshold SOC1, the processing proceeds to Step S16 (Step S14: NO).

In Step S15, the temperature controller 37 sets the heating stop temperature Th to the temperature Th1, which is lower than the heating stop reference temperature Ths, and sets the cooling start temperature Tc to the temperature Tc1, which is lower than the cooling start reference temperature Tcs.

In Step S16, the temperature controller 37 determines whether the obtained SOC value is lower than the second threshold SOC2 or not. If the SOC value is lower than the second threshold SOC2, i.e., if the SOC is the normal state, the processing proceeds to Step S17 (Step S16: YES). If the SOC value is not lower than the second threshold SOC2, i.e., if the SOC value is higher than or equal to the second threshold SOC2 and is in the high SOC, the processing proceeds to Step S18 (Step S16: NO).

In Step S17, the temperature controller 37 sets the heating stop temperature Th to the heating stop reference temperature Ths, and sets the cooling start temperature Tc to the cooling start reference temperature Tcs.

In Step S18, the temperature controller 37 sets the heating stop temperature Th to the temperature Th2, which is higher than the heating stop reference temperature Ths, and sets the cooling start temperature Tc to the temperature Tc2, which is higher than the cooling start reference temperature Tcs.

By execution of the processes in Step S15, S17, or S18, the SOC is reflected in the temperature control for the battery cell 21. Thus, the present processing is finished.

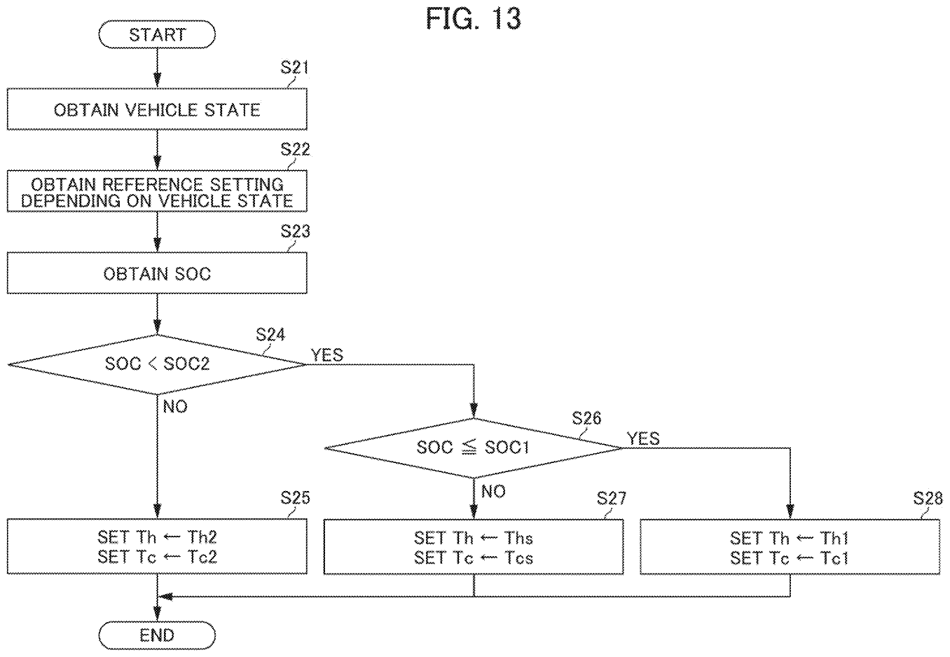

Here, FIG. 13 is a flowchart showing another example of the flow of the process of setting the heating temperature range and the cooling temperature range based on the SOC. In the other example, processes in Steps S21 to S23 are the same as those in Steps S11 to S13 in the example described above. However, the other example is different in that the processes in Steps S24 to S28 are different from the processes in Steps S14 to S18 in the example described above.

The processes in Steps S21 to S23 are the same processes in Steps S11 to S13 in the example described above. Accordingly, the description thereof is omitted.

In Step S24, the temperature controller 37 determines whether the obtained SOC value is lower than the second threshold SOC2 or not. If the SOC value is not lower than the second threshold SOC2, i.e., if the SOC value is higher than or equal to the second threshold SOC2 and is in the high SOC, the processing proceeds to Step S25 (Step S24: NO). If the SOC value is lower than the second threshold SOC2, the processing proceeds to Step S26 (Step S24: YES).

In Step S25, the temperature controller 37 sets the heating stop temperature Th to the temperature Th2, which is higher than the heating stop reference temperature Ths, and sets the cooling start temperature Tc to the temperature Tc2, which is higher than the cooling start reference temperature Tcs.

In Step S26, the temperature controller 37 determines whether or not the obtained SOC value is lower than or equal to the first threshold SOC1. If the SOC value is not lower than or equal to the first threshold SOC1, i.e., if the SOC is the normal state, the processing proceeds to Step S27 (Step S26: NO). If the SOC value is lower than or equal to the first threshold SOC1, i.e., in the low SOC, the processing proceeds to Step S28 (Step S26: YES).

In Step S27, the temperature controller 37 sets the heating stop temperature Th to the heating stop reference temperature Ths, and sets the cooling start temperature Tc to the cooling start reference temperature Tcs.

In Step S28, the temperature controller 37 sets the heating stop temperature Th to the temperature Th1, which is lower than the heating stop reference temperature Ths, and sets the cooling start temperature Tc to the temperature Tc1, which is lower than the cooling start reference temperature Tcs.

By execution of the processes in Step S25, S27, or S28, the SOC is reflected in the temperature control for the battery cell 21. Thus, the present processing is finished.

As described above, in the example shown in FIG. 12, first, it is determined whether the state is the low SOC or not. If it is in the low SOC, the heating stop temperature Th is set to the temperature Th1, which is lower than the heating stop reference temperature Ths, and sets the cooling start temperature Tc to the temperature Tc1, which is lower than the cooling start reference temperature Tcs, and the processing is finished. In contrast, in the other example shown in FIG. 13, first, it is determined whether the state is the high SOC or not. If it is in the high SOC, the heating stop temperature Th is set to the temperature Th2, which is higher than the heating stop reference temperature Ths, and sets the cooling start temperature Tc to the temperature Tc2, which is higher than the cooling start reference temperature Tcs, and the processing is finished. In all the examples, the SOC, which affects the heat transfer characteristics, can be reflected in the temperature control for the battery cell 21, thereby allowing the efficiency of the entire system to be improved.

As described above, in the first control mode, the setting of the heating stop temperature and the cooling start temperature is changed depending on the SOC. The setting of the heating stop temperature and the cooling start temperature may be changed also based on the contact surface pressure between the battery cell 21 and the elastic member 22 obtained by the surface pressure obtainer 35 in addition to the SOC. Specifically, as the contact surface pressure increases, the thermal conductance between the battery cell 21 and the elastic member 22 increases and the temperature of the battery cell 21 decreases, thereby increasing the heating stop temperature and the cooling start temperature. In contrast, as the contact surface pressure decreases, the thermal conductance between the battery cell 21 and the elastic member 22 decreases and the temperature of the battery cell 21 increases, thereby reducing the heating stop temperature and the cooling start temperature. Accordingly, by changing the setting of the heating stop temperature and the cooling start temperature also based on the contact surface pressure that can be directly obtained by a pressure sensor or the like, the temperature can be more accurately controlled, and the efficiency of the entire system can be more improved.

### Second Control Mode

### <Setting of Heating Capability and Cooling Capability>

Next, a second control mode of the temperature controller 37 where a heating capability and a cooling capability are changed depending on the SOC of the battery pack 2 is described. The second control mode is for thermal management control of increasing the heating capability of the temperature adjuster and reducing the cooling capability of the temperature adjuster as the low SOC transitions to the high SOC in accordance with the characteristics of variation in thermal conductance between the battery cell 21 and the elastic member 22 depending on the SOC of the battery.

Specifically, since there is a tendency that the thermal conductance between the battery cell 21 and the elastic member 22 increase and the temperature of the battery cell 21 decreases if the SOC is higher than or equal to a predetermined SOC, in the second control mode the temperature controller 37 sets the heating capability of the temperature adjuster described above higher than a heating reference capability that is a reference capability for heating, and sets the cooling capability of the temperature adjuster lower than a cooling reference capability that is a reference capability for cooling.

Since there is a tendency that the thermal conductance between the battery cell 21 and the elastic member 22 decrease and the temperature of the battery cell 21 increases if the SOC is lower than or equal to a predetermined SOC different from the predetermined SOC described above, in the second control mode the temperature controller 37 sets the heating capability of the temperature adjuster described above lower than the heating reference capability, and sets the cooling capability of the temperature adjuster higher than the cooling reference capability.

In the present embodiment, the heating reference capability and the cooling reference capability are set based on the vehicle state obtained by the vehicle state obtainer 36, and the heating capability and the cooling capability are set based on the SOC. As described in the first control mode as the example, it is assumed that the heating reference capability and the cooling reference capability are set for the vehicle state of traveling, left (after travel), charging (normal charging), charging (fast charging), left (after charging), or heat retention. Note that the heating reference capability and the cooling reference capability may be set to the same capability between the vehicle states.

Preferably, similar to the first control mode, the SOC to be determined in the second control mode is classified into a plurality of regions. Also in the second control mode, the number of classified regions is not specifically limited. Similar to the first control mode, the SOC is classified into three regions that are the low SOC, the normal state, and the high SOC. For example, if the SOC is lower than or equal to a first threshold SOC1 (SOC≤SOC1), the SOC is determined as the low SOC. If the SOC is higher than or equal to a second threshold SOC2 that is higher than the first threshold SOC1 (SOC≥SOC2), the SOC is determined as the high SOC. If the SOC is higher than the first threshold SOC1 and lower than the second threshold SOC2 (SOC1<SOC<SOC2), the SOC is determined as the normal state. The first threshold SOC1 and the second threshold SOC2 are set to arbitrarily selected values depending on the battery characteristics.

In the case where the SOC is the normal state, the heating capability and the cooling capability are not changed from the heating reference capability and the cooling reference capability. In the case of the low SOC, the thermal conductance between the battery cell 21 and the elastic member 22 decreases and the temperature of the battery cell 21 increases. Accordingly, the cooling capability is changed to an enhanced cooling capability that has a higher cooling power than the cooling reference capability, and the heating capability is changed to a reduced heating capability that has a lower heating power than the heating reference capability. On the other hand, in the case of the high SOC, the thermal conductance between the battery cell 21 and the elastic member 22 increases and the temperature of the battery cell 21 decreases. Accordingly, the cooling capability is changed to a reduced cooling capability that has a lower cooling power than the cooling reference capability, and the heating capability is changed to an enhanced heating capability that has a higher heating power than the heating reference capability.

As described above, as the SOC increases, the cooling capability is set lower, and the heating capability is set higher.

The change of the cooling capability is not specifically limited. Various schemes can be employed. For example, the enhancement of the cooling capability can be achieved by increasing the flow rate of the thermal medium through increasing the power consumption of the liquid deliverer 11 that is an electric water pump under cooling control. In the case of using the heat exhauster 16 such as a chiller that uses a compressor for the cold water circuit 10, the enhancement of the cooling capability can also be achieved by improving the cooling capability of the heat exhauster 16 through increasing the rotation speed of the compressor or the like.

On the other hand, the reduction of the cooling capability can be achieved by reducing the flow rate of the thermal medium through reducing the power consumption of the liquid deliverer 11 under cooling control. In the case of using the heat exhauster 16 such as a chiller, the reduction of the cooling capability can also be achieved by reducing the cooling capability of the heat exhauster 16 through reducing the rotation speed of the compressor or the like. In the case of using a radiator or the like as the heat exhauster 16, the reduction of the cooling capability can also be achieved by reducing the cooling capability of the heat exhauster 16, such as the radiator, through closing the airflow rate adjuster 13, such as AGS.

The change of the heating capability is not specifically limited. Various schemes can be employed. For example, the reduction of the heating capability can be achieved by reducing the flow rate of the thermal medium through reducing the power consumption of the liquid deliverer 11 under heating control. The reduction of the heating capability can also be achieved by reducing the output of the heater device 12 and reducing the heat quantity to be added to the thermal medium.

On the other hand, the enhancement of the heating capability can be achieved by increasing the flow rate of the thermal medium through increasing the power consumption of the liquid deliverer 11 under heating control. The enhancement of the heating capability can also be achieved by increasing the output of the heater device 12 and increasing the heat quantity to be added to the thermal medium.

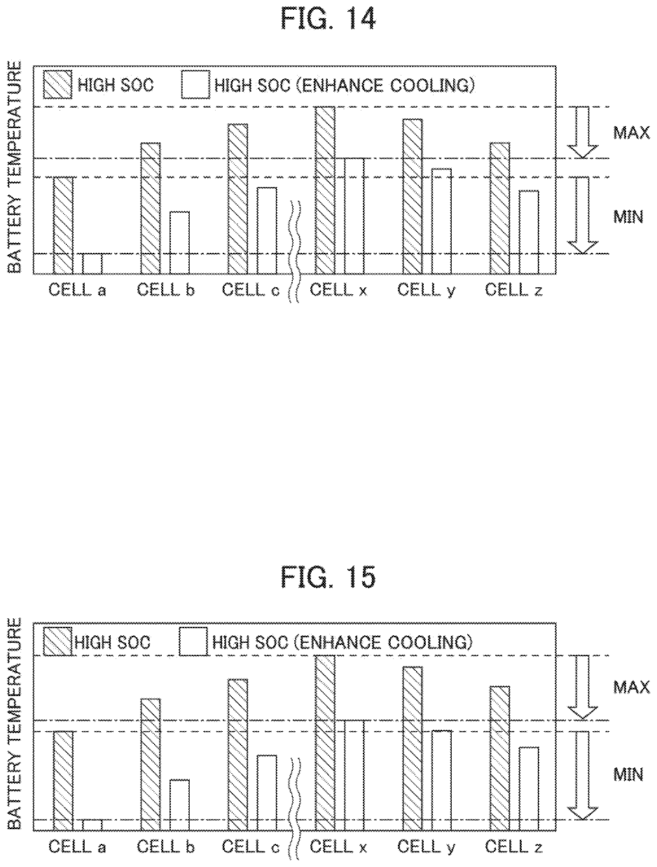

FIG. 14 is a graph showing the comparison of the battery cell 21 with the temperature distribution between the case of setting the cooling reference capability and the case of setting the enhanced cooling capability at elapsed time t1 under applied current in FIG. 7. FIG. 15 is a graph showing the comparison of the battery cell 21 with the temperature distribution between the case of setting the cooling reference capability and the case of setting the enhanced cooling capability at elapsed time t2 under applied current in FIG. 7.

FIGS. 14 and 15 show the temperature distribution of the battery cell 21 in the case of cooling with the cooling reference capability in the high SOC, and the temperature distribution of the battery cell 21 in the case of cooling with the enhanced cooling capability in the high SOC. Cells a, b, c, . . . , x, y, z are stacked and provided in this order along the first direction of the battery module 20 with the elastic members 22 being interposed in an alternating manner, thus constituting the respective battery cells 21 in the battery module 20. As for the battery module 20, the cells a to z are provided symmetrically with respect to the center plate 24. That is, the cells z are provided on the opposite sides of the center plate 24 with the corresponding elastic member 22 being interposed. The graphs in FIGS. 14 and 15 show that in both cases at elapsed time t1 and elapsed time t2, the temperature of the entire battery module 20 can be reduced by enhancing the cooling capability. At elapsed time t2 shown in FIG. 15, in comparison with elapsed time t1 shown in FIG. 14, the reduction in temperature in the case of cooling with the enhanced cooling capability is more significant than the case with cooling with the cooling reference capability. According to the graphs in FIGS. 14 and 15, the characteristics of variation in the thermal conductance of the battery cell 21 that expands and contracts can be supported also by enhancing the cooling capability instead of the control of moving the cooling start temperature to an earlier time such as in the first control mode.

### <Flow of Process in Second Control Mode>

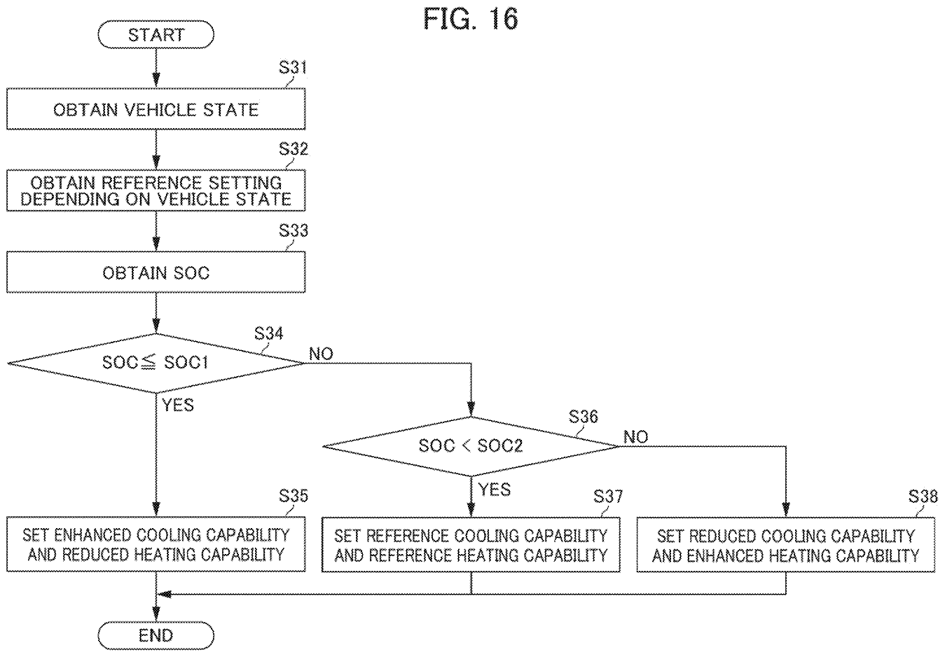

Next, referring to FIG. 16, the flow of a process of setting the heating capability and the cooling capability is described. FIG. 16 is a flowchart showing an example of the flow of the process of setting the heating capability and the cooling capability based on the SOC.

In Step S31, the vehicle state obtainer 36 obtains the vehicle state signal from the vehicle control device 50.

In Step S32, the temperature controller 37 obtains reference setting (reference capability) preset depending on the vehicle state. In the second control mode, the temperature controller 37 obtains the cooling reference capability and the heating reference capability as reference setting.

In Step S33, the remaining charge obtainer 33 obtains the SOC that indicates the state of charge of the battery pack 2 (battery cells 21).

In Step S34, the temperature controller 37 determines whether or not the obtained SOC value is lower than or equal to the first threshold SOC1. If the SOC value is lower than or equal to the first threshold SOC1, i.e., in the low SOC, the processing proceeds to Step S35 (Step S34: YES). If the SOC value is not lower than or equal to the first threshold SOC1, the processing proceeds to Step S36 (Step S34: NO).

In Step S35, the temperature controller 37 enhances the cooling capability of the temperature adjuster, and reduces the heating capability. Accordingly, when a cooling request is issued, a state of executing cooling control based on the enhanced cooling capability is established. When a heating request is issued, a state of executing heating control based on the reduced heating capability is established.

In Step S36, the temperature controller 37 determines whether the obtained SOC value is lower than the second threshold SOC2 or not. If the SOC value is lower than the second threshold SOC2, i.e., if the SOC is the normal state, the processing proceeds to Step S37 (Step S36: YES). If the SOC value is not lower than the second threshold SOC2, i.e., if the SOC value is higher than or equal to the second threshold SOC2 and is in the high SOC, the processing proceeds to Step S38 (Step S36: NO).

In Step S37, the temperature controller 37 sets the normal cooling reference capability and heating reference capability as they are. Accordingly, when a cooling request is issued, a state of executing cooling control based on the cooling reference capability is established. When a heating request is issued, a state of executing heating control based on the heating reference capability is established.

In Step S38, the temperature controller 37 reduces the cooling capability, and enhances the heating capability. Accordingly, when a cooling request is issued, a state of executing cooling control based on the reduced cooling capability is established. When a heating request is issued, a state of executing heating control based on the enhanced heating capability is established.

By execution of the processes in Step S35, S37, or S38, the SOC is reflected in the temperature control for the battery cell 21. Thus, the present processing is finished.

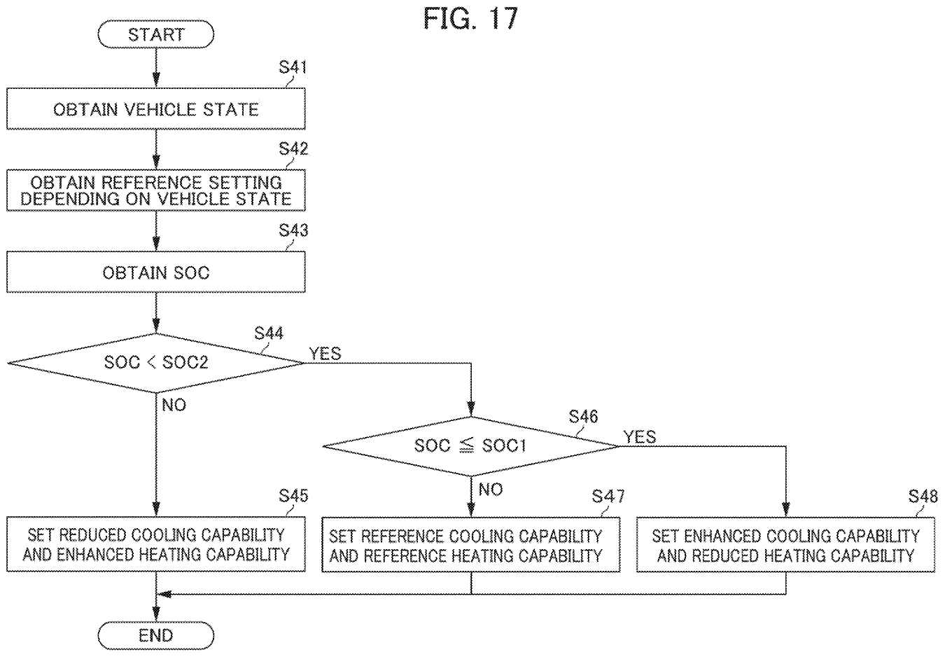

FIG. 17 is a flowchart showing another example of the flow of the process of setting the heating capability and the cooling capability based on the SOC. In the other example, processes in Steps S41 to S43 are the same as those in Steps S31 to S33 in the example described above. However, the other example is different in that the processes in Steps S44 to S48 are different from those in Steps S34 to S38 in the example described above.

The processes in Steps S41 to S43 are the same processes in Steps S31 to S33 in the example described above. Accordingly, the description thereof is omitted.

In Step S44, the temperature controller 37 determines whether the obtained SOC value is lower than the second threshold SOC2 or not. If the SOC value is not lower than the second threshold SOC2, i.e., if the SOC value is higher than or equal to the second threshold SOC2 and is in the high SOC, the processing proceeds to Step S45 (Step S44: NO). If the SOC value is lower than the second threshold SOC2, the processing proceeds to Step S46 (Step S44: YES).

In Step S45, the temperature controller 37 reduces the cooling capability of the temperature adjuster, and enhances the heating capability. Accordingly, when a cooling request is issued, a state of executing cooling control based on the reduced cooling capability is established. When a heating request is issued, a state of executing heating control based on the enhanced heating capability is established.

In Step S46, the temperature controller 37 determines whether or not the obtained SOC value is lower than or equal to the first threshold SOC1. If the SOC value is not lower than or equal to the first threshold SOC1, i.e., if the SOC is the normal state, the processing proceeds to Step S47 (Step S46: NO). If the SOC value is lower than or equal to the first threshold SOC1, i.e., in the low SOC, the processing proceeds to Step S48 (Step S46: YES).

In Step S47, the temperature controller 37 sets the normal cooling reference capability and heating reference capability as they are. Accordingly, when a cooling request is issued, a state of executing cooling control based on the cooling reference capability is established. When a heating request is issued, a state of executing heating control based on the heating reference capability is established.

In Step S48, the temperature controller 37 enhances the cooling capability, and reduces the heating capability. Accordingly, when a cooling request is issued, a state of executing cooling control based on the enhanced cooling capability is established. When a heating request is issued, a state of executing heating control based on the reduced heating capability is established.

By execution of the processes in Step S45, S47, or S48, the SOC is reflected in the temperature control for the battery cell 21. Thus, the present processing is finished.

As described above, in the example shown in FIG. 16, first, it is determined whether the state is the low SOC or not. In the case of the low SOC, the cooling capability of the temperature adjuster is set to the enhanced cooling capability, and the heating capability of the temperature adjuster is set to the reduced heating capability, and the processing is finished. On the other hand, in the other example shown in FIG. 17, first, it is determined whether the state is the high SOC or not. In the case of the high SOC, the cooling capability of the temperature adjuster is set to the reduced cooling capability, and the heating capability of the temperature adjuster is set to the enhanced heating capability, and the processing is finished. In all the examples, the SOC, which affects the heat transfer characteristics, can be reflected in the temperature control for the battery cell 21, thereby allowing the efficiency of the entire system to be improved.

Note that as described above, in the second control mode, the setting of the heating capability and the cooling capability of the temperature adjuster is changed depending on the SOC. The setting of the heating capability and the cooling capability of the temperature adjuster may be changed also based on the contact surface pressure between the battery cell 21 and the elastic member 22 obtained by the surface pressure obtainer 35 in addition to the SOC. Specifically, as the contact surface pressure increases, the thermal conductance between the battery cell 21 and the elastic member 22 increases and the temperature of the battery cell 21 decreases, thereby enhancing the heating capability of the temperature adjuster and reducing the cooling capability. In contrast, as the contact surface pressure decreases, the thermal conductance between the battery cell 21 and the elastic member 22 decreases and the temperature of the battery cell 21 increases, thereby reducing the heating capability of the temperature adjuster and enhancing the cooling capability. Accordingly, by changing the setting of the heating capability and the cooling capability of the temperature adjuster also based on the contact surface pressure that can be directly obtained by a pressure sensor or the like, the temperature can be more accurately controlled, and the efficiency of the entire system can be more improved.

The advantageous effects of the present embodiment described above are summarized as follows.

The battery system 1 in the first control mode in the present embodiment includes the battery cell 21 that expands and contracts depending on the remaining charge, and the elastic member 22 that provided is adjacent to the battery cell 21 and has the contact surface pressure against the battery cell 21 changing depending on the expansion and contraction of the battery cell 21, and includes the temperature controller 37 that executes heating or cooling of the battery cell 21 based on the preset reference temperature, and the remaining charge obtainer 33 that obtains the state of the remaining charge of the battery cell 21. If the remaining charge is equal to or greater than a predetermined value, the temperature controller 37 sets the heating stop temperature higher than the heating stop reference temperature Ths, and sets the cooling start temperature higher than the cooling start reference temperature Tcs. On the other hand, if the remaining charge is equal to or less than the predetermined value, the temperature controller 37 sets the heating stop temperature lower than the heating stop reference temperature Ths, and sets the cooling start temperature lower than the cooling start reference temperature Tcs.

The interfacial thermal conductance depends on the state of charge of the battery. Accordingly, in a case where the thermal management control is uniformly constructed irrespective of the state of charge, heating/cooling becomes insufficient, or heating/cooling becomes excessive, thus reducing the control efficiency. The interfacial thermal conductance between the battery cell 21 and the elastic member 22 changes depending on the surface pressure. Accordingly, when the low SOC and the high SOC are compared, the low SOC tends to have a high cell temperature. As described above, the battery cell 21 has a temperature tendency varying depending on the state of charge of the battery. Accordingly, the control based on the characteristics is required to be constructed. In this viewpoint, since in the low SOC, the thermal conductance between the battery cell 21 and the elastic member 22 decreases and the temperature of the battery cell 21 increases, the battery system 1 in the present embodiment performs thermal management control that makes the heating stop temperature and the cooling start temperature relatively low, and moves the heating stop and the cooling start to earlier times. On the other hand, in the high SOC, the thermal conductance between the battery cell 21 and the elastic member 22 increases and the temperature of the battery cell 21 decreases. Accordingly, thermal management control that makes the heating stop temperature and the cooling start temperature relatively high, and delays the heating stop and the cooling start is performed. Accordingly, the variation in thermal conductance caused by the change in contact surface pressure between the battery cell 21 and the elastic member 22 can be accurately reflected in the temperature control for the battery cell 21, and the entire system can be made more efficient.

The battery system 1 in the second control mode in the present embodiment includes the battery cell 21 that expands and contracts depending on the remaining charge, and the elastic member 22 that is provided adjacent to the battery cell 21 and has the contact surface pressure against the battery cell 21 changing depending on the expansion and contraction of the battery cell 21, and further includes: the temperature adjuster that includes the liquid deliverer 11, the heater device 12, the airflow rate adjuster 13, and the heat exhauster 16; the temperature controller 37 that executes heating or cooling of the battery cell 21 based on the preset reference capability of the temperature adjuster; and the remaining charge obtainer 33 that obtains the state of the remaining charge of the battery cell 21. If the remaining charge is more than or equal to the predetermined value, the temperature controller 37 sets the heating capability of the temperature adjuster higher than the heating reference capability, and sets the cooling capability of the temperature adjuster lower than the cooling reference capability. On the other hand, if the remaining charge is equal to or less than the predetermined value, the temperature controller 37 sets the heating capability of the temperature adjuster lower than the heating reference capability, and sets the cooling capability of the temperature adjuster higher than the cooling reference capability.

That is, since in the low SOC, the thermal conductance between the battery cell 21 and the elastic member 22 decreases and the temperature of the battery cell 21 increases, the battery system 1 in the present embodiment performs thermal management control that enhances the cooling capability and reduces the heating capability. On the other hand, since in the high SOC, the thermal conductance between the battery cell 21 and the elastic member 22 increases and the temperature of the battery cell 21 decreases, thermal management control that reduces the cooling capability and enhances the heating capability is performed. Accordingly, the variation in thermal conductance caused by the change in contact surface pressure between the battery cell 21 and the elastic member 22 can be accurately reflected in the temperature control for the battery cell 21, and the entire system can be made more efficient.

The temperature controller 37 in the present embodiment may determine which region among a plurality of preset regions the remaining charge obtained by the remaining charge obtainer 33 belongs to, and set the heating stop temperature and the cooling start temperature based on the determination result. Accordingly, the variation in thermal conductance caused by the change in contact surface pressure between the battery cell 21 and the elastic member 22 can be more securely reflected in the temperature control for the battery cell 21, and the efficiency of the entire system can be more securely improved.

The temperature controller 37 in the present embodiment may determine which region among a plurality of preset regions the remaining charge obtained by the remaining charge obtainer 33 belongs to, and set the heating capability and the cooling capability of the temperature adjuster based on the determination result. Accordingly, the variation in thermal conductance caused by the change in contact surface pressure between the battery cell 21 and the elastic member 22 can be more securely reflected in the temperature control for the battery cell 21, and the efficiency of the entire system can be more securely improved.

The battery system 1 in the present embodiment may further include the surface pressure obtainer 35 that obtains the contact surface pressure between the battery cell 21 and the elastic member 22. The temperature controller 37 may set the heating stop temperature and the cooling start temperature, based on the remaining charge and the contact surface pressure. By changing the setting of the heating stop temperature and the cooling start temperature also based on the contact surface pressure that can be directly obtained by a pressure sensor or the like in addition to the remaining charge, the temperature can be more accurately controlled, and the efficiency of the entire system can be more improved.

The battery system 1 in the present embodiment may further include the surface pressure obtainer 35 that obtains the contact surface pressure between the battery cell 21 and the elastic member 22. The temperature controller 37 may set the heating capability and the cooling capability, based on the remaining charge and the contact surface pressure. By changing the setting of the heating capability and the cooling capability of the temperature adjuster also based on the contact surface pressure that can be directly obtained by a pressure sensor or the like in addition to the remaining charge, the temperature can be more accurately controlled, and the efficiency of the entire system can be more improved.

The battery system 1 in the present embodiment may further include the vehicle state obtainer 36 that obtains the vehicle state. The temperature controller 37 may set the heating stop temperature and the cooling start temperature, based on the remaining charge and the vehicle state. Accordingly, the temperature control in consideration of the vehicle state along with the variation in thermal conductance can be achieved, and the efficiency of the entire system can be more improved.

The battery system 1 in the present embodiment may further include the vehicle state obtainer 36 that obtains the vehicle state. The temperature controller 37 may set the heating capability and the cooling capability of the temperature adjuster, based on the remaining charge and the vehicle state. Specifically in the traveling, normal charging, and fast charging states among the vehicle states of traveling, left after travel, normal charging, fast charging, left after charging, and heat retention, the remaining charge tends to change. Meanwhile, according to the present embodiment, even in these traveling, normal charging, and fast charging cases, the setting of the heating capability and the cooling capability of the temperature adjuster is changed based on the remaining charge and the vehicle state. Accordingly, the variation in thermal conductance can be more accurately reflected in the temperature control of the battery cell 21, and the efficiency of the entire system can be more improved.

The battery system 1 in the present embodiment may include, as the temperature adjuster, the liquid deliverer 11 that controls the flow rate of the thermal medium that is to be supplied to the battery cell 21. The temperature controller 37 may change the flow rate of the thermal medium by the liquid deliverer 11, based on the remaining charge. Alternatively, the battery system 1 in the present embodiment may include, as the temperature adjuster, the heat exhauster 16 that cools the thermal medium that is to be supplied to the battery cell 21. The temperature controller 37 may change the cooling setting of the heat exhauster 16, based on the remaining charge. Alternatively, the battery system 1 in the present embodiment may include, as the temperature adjuster, the heater device 12 that heats the thermal medium that is to be supplied to the battery cell 21. The temperature controller 37 may change the heating setting of the heater device 12, based on the remaining charge. Alternatively, the battery system 1 in the present embodiment may include, as the temperature adjuster, the heat exhauster 16 provided in a circuit through which the thermal medium to be supplied to the battery cell 21 circulates, and the airflow rate adjuster 13 that can adjust the airflow rate to be supplied to the heat exhauster 16. The temperature controller 37 may control the airflow rate adjuster 13, based on the remaining charge. In both cases, the temperature control that accommodates variation in thermal conductance can be more securely achieved. The efficiency of the entire system can be more securely improved.

In the battery system 1 in the present embodiment, the battery cell 21 may be an all-solid-state battery. The all-solid-state battery, which has a volume difference between expansion and contraction in comparison with a semi-solid-state battery, has larger variation in thermal conductance. In this viewpoint, according to the present embodiment, the temperature control is executed in consideration of the variation in thermal conductance. Consequently, more efficient temperature control can be achieved.

In the battery system 1 in the present embodiment, the negative electrode of the battery cell 21 may have a configuration that contains Li metal or Li alloy. Accordingly, for the battery cell 21 applied to the negative electrode that contains Li metal or Li alloy, the temperature control that accommodates variation in thermal conductance can be achieved.

In the battery system 1 in the present embodiment, the negative electrode of the battery cell 21 may have a configuration that contains Si or Si alloy. Accordingly, for the battery cell 21 applied to the negative electrode that contains Si or Si alloy, the temperature control that accommodates variation in thermal conductance can be achieved.

An embodiment of the present invention has been described above. However, there is no limitation to the embodiment described above. The advantageous effects described in the aforementioned embodiment are only listed as preferable advantageous effects. There is no limitation to those described in the aforementioned embodiment.

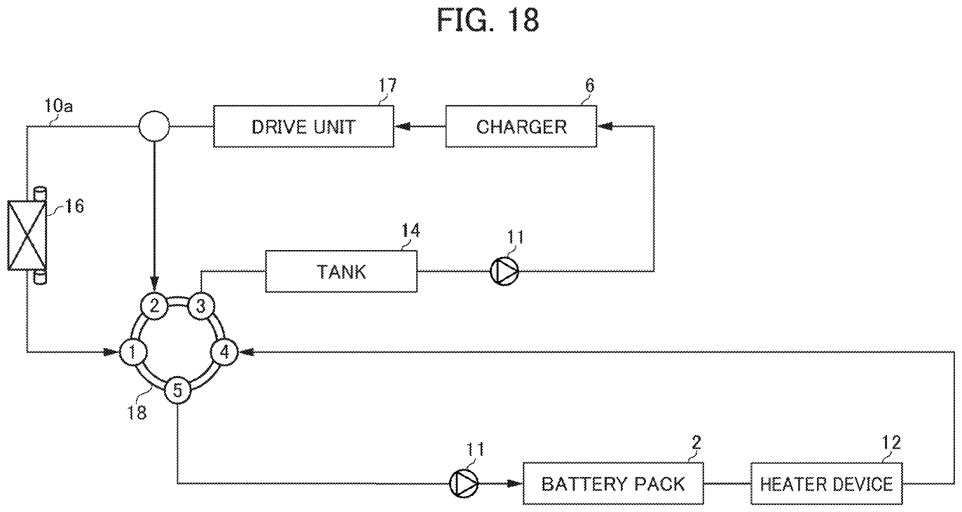

For example, the present invention is also applicable to a battery system 1 that includes a cold water circuit 10a as shown in FIG. 18. FIG. 18 shows the cold water circuit 10a of the battery system 1 according to a modified example. Note that the components common or similar to those in the embodiment described above are assigned the same symbols. As shown in FIG. 18, a liquid deliverer 11, a battery pack 2, a heater device 12, a tank 14, a charger 6, a drive unit 17, a heat exhauster 16 that is, for example, a radiator or the like, and a five-way valve 18 are provided in the cold water circuit 10a. The cold water circuit 10a cools the battery pack 2, the drive unit 17, the charger 6 and the like while switching the path by the five-way valve 18. Also in such a modified example, the change in heat transfer characteristics can be accurately reflected in the temperature control of the battery cell 21.

The battery system 1 in the aforementioned embodiment has been described as having the configuration that can execute both the first control mode for changing the setting of the heating stop temperature and the cooling start temperature, and the second control mode for changing the setting of the heating capability and the cooling capability. However, a configuration that executes control in only one of the first control mode and the second control mode may be employed. Alternatively, a configuration that changes the setting of only one of the heating stop temperature and the cooling start temperature may be employed. A configuration that changes the setting of only one of the heating capability and the cooling capability may be employed.

The battery system 1 in the aforementioned embodiment has been described as having the configuration that includes the surface pressure obtainer 35 and the vehicle state obtainer 36. However, a configuration that does not include these function units may be employed.

The battery system 1 in the aforementioned embodiment has been described as having a configuration that includes the liquid deliverer 11, the heater device 12, the airflow rate adjuster 13, and the heat exhauster 16, as the temperature adjuster. However, not all of the components need to be provided as long as the heating control and the cooling control for the battery cell 21 can be achieved.

Note that according to the embodiment described above, the control method for the battery system 1 executed by the battery system 1, and the program for causing a computer to execute the control method are also provided. The control method for the battery system 1 is executed by the CPU of the battery ECU 3, and the program is stored in the memory of the battery ECU 3. According to the control method for the battery system 1, and the program for causing a computer to execute the control method, advantageous effects similar to those of the battery system 1 described above are achieved.

### EXPLANATION OF REFERENCE NUMERALS

1 Battery system
2 Battery pack
3 Battery ECU
11 Liquid deliverer
12 Heater device
13 Airflow rate adjuster
16 Heat exhauster
20 Battery module
21 Battery cell
22 Elastic member
31 Battery temperature obtainer
32 Battery voltage obtainer
33 Remaining charge obtainer
35 Surface pressure obtainer
36 Vehicle state obtainer
37 Temperature controller

What is claimed is:

1. A battery system comprising:
a battery cell that expands and contracts depending on a remaining charge; and
an elastic member that is provided adjacent to the battery cell, and has a contact surface pressure against the battery cell that changes depending on expansion and contraction of the battery cell, the battery system comprising:
a temperature controller configured to execute heating or cooling of the battery cell based on a preset reference temperature; and
a remaining charge obtainer configured to obtain a state of the remaining charge of the battery cell,
wherein, when the remaining charge is equal to or greater than a predetermined value, the temperature controller sets a heating stop temperature at which the heating is stopped to be higher than a heating stop reference temperature which is the reference temperature at which the heating is stopped, and sets a cooling start temperature at which the cooling is started to be higher than a cooling start reference temperature which is the reference temperature at which the cooling is started.

2. A battery system comprising:
a battery cell that expands and contracts depending on a remaining charge; and
an elastic member that is provided adjacent to the battery cell, and has a contact surface pressure against the battery cell that changes depending on expansion and contraction of the battery cell, the battery system comprising:
a temperature controller configured to execute heating or cooling of the battery cell, based on a preset reference temperature; and
a remaining charge obtainer configured to obtain a state of the remaining charge of the battery cell,
wherein, when the remaining charge is equal to or less than a predetermined value, the temperature controller sets a heating stop temperature at which the heating is stopped to be lower than a heating stop reference temperature which is the reference temperature at which the heating is stopped, and sets a cooling start temperature at which the cooling is started to be lower than a cooling start reference temperature which is the reference temperature at which the cooling is started.

3. A battery system comprising:
a battery cell that expands and contracts depending on a remaining charge; and
an elastic member that is provided adjacent to the battery cell, and has a contact surface pressure against the battery cell that changes depending on expansion and contraction of the battery cell, the battery system comprising:
a temperature adjuster;
a temperature controller configured to execute heating or cooling of the battery cell based on a preset reference capability of the temperature adjuster; and
a remaining charge obtainer configured to obtain a state of the remaining charge of the battery cell,
wherein, when the remaining charge is equal to or greater than a predetermined value, the temperature controller sets a heating capability of the temperature adjuster to be higher than a heating reference capability which is the reference capability for the heating, and sets a cooling capability of the temperature adjuster to be lower than a cooling reference capability which is the reference capability for the cooling.

4. A battery system comprising:
a battery cell that expands and contracts depending on a remaining charge; and
an elastic member that is provided adjacent to the battery cell, and has a contact surface pressure against the battery cell that changes depending on expansion and contraction of the battery cell, the battery system comprising:
a temperature adjuster;
a temperature controller configured to execute heating or cooling of the battery cell based on a preset reference capability of the temperature adjuster; and
a remaining charge obtainer configured to obtain a state of the remaining charge of the battery cell,
wherein, when the remaining charge is equal to or less than a predetermined value, the temperature controller sets a heating capability of the temperature adjuster to be lower than a heating reference capability which is the reference capability for the heating, and sets a cooling capability of the temperature adjuster to be higher than a cooling reference capability which is the reference capability for the cooling.

5. The battery system according to claim 1, wherein the temperature controller determines which region among a plurality of preset regions the remaining charge belongs to, and sets the heating stop temperature and the cooling start temperature based on a result of the determination.

6. The battery system according to claim 2, wherein the temperature controller determines which region among a plurality of preset regions the remaining charge belongs to, and sets the heating stop temperature and the cooling start temperature based on a result of the determination.

7. The battery system according to claim 1, further comprising a surface pressure obtainer configured to obtain a contact surface pressure between the battery cell and the elastic member,
wherein the temperature controller sets the heating stop temperature and the cooling start temperature based on the contact surface pressure.

8. The battery system according to claim 2, further comprising a surface pressure obtainer configured to obtain a contact surface pressure between the battery cell and the elastic member,
wherein the temperature controller sets the heating stop temperature and the cooling start temperature based on the contact surface pressure.

9. The battery system according to claim 3, wherein the temperature controller determines which region among a plurality of preset regions the remaining charge belongs to, and sets the heating capability and the cooling capability based on a result of the determination.

10. The battery system according to claim 4, wherein the temperature controller determines which region among a plurality of preset regions the remaining charge belongs to, and sets the heating capability and the cooling capability based on a result of the determination.

11. The battery system according to claim 3, further comprising a surface pressure obtainer configured to obtain a contact surface pressure between the battery cell and the elastic member,
wherein the temperature controller sets the heating capability and the cooling capability based on the contact surface pressure.

12. The battery system according to claim 4, further comprising a surface pressure obtainer configured to obtain a contact surface pressure between the battery cell and the elastic member,
wherein the temperature controller sets the heating capability and the cooling capability based on the contact surface pressure.

13. The battery system according to claim 1, further comprising a vehicle state obtainer configured to obtain a vehicle state,
wherein the temperature controller sets the heating stop temperature and the cooling start temperature based on the vehicle state.

14. The battery system according to claim 2, further comprising a vehicle state obtainer configured to obtain a vehicle state,
wherein the temperature controller sets the heating stop temperature and the cooling start temperature based on the vehicle state.

15. The battery system according to claim 3 further comprising a vehicle state obtainer configured to obtain a vehicle state,
wherein the temperature controller sets the heating capability and the cooling capability based on the vehicle state.

16. The battery system according to claim 4 further comprising a vehicle state obtainer configured to obtain a vehicle state,
wherein the temperature controller sets the heating capability and the cooling capability based on the vehicle state.

17. The battery system according to claim 3, wherein
the temperature adjuster includes a liquid deliverer configured to control a flow rate of a thermal medium that is to be supplied to the battery cell, and
the temperature controller changes the flow rate of the thermal medium controlled by the liquid deliverer based on the remaining charge.

18. The battery system according to claim 4, wherein
the temperature adjuster includes a liquid deliverer configured to control a flow rate of a thermal medium that is to be supplied to the battery cell, and
the temperature controller changes the flow rate of the thermal medium controlled by the liquid deliverer based on the remaining charge.

19. The battery system according to claim 3, wherein
the temperature adjuster includes a heat exhauster configured to cool a thermal medium that is supplied to the battery cell, and
the temperature controller changes a cooling setting for the heat exhauster based on the remaining charge.

20. The battery system according to claim 4, wherein
the temperature adjuster includes a heat exhauster configured to cool a thermal medium that is supplied to the battery cell, and
the temperature controller changes a cooling setting for the heat exhauster based on the remaining charge.
